(19) United States
(12) Patent Application Publication
(10) Pub. No.: US 2026/0246000 A1
(43) Pub. Date: Aug. 20, 2026

(54) METHOD FOR RECYCLING GRAPHITE AND RECYCLED GRAPHITE

(71) Applicant: VIANODE AS, Oslo (NO)

(72) Inventors: Gunstein SKOMEDAL, Kristiansand (NO); Bridget Catherine DEVENEY, Kristiansand (NO)

(21) Appl. No.: 19/480,317

(22) PCT Filed: May 2, 2024
(86) PCT No.: PCT/NO2024/050106

§ 371 Date: Oct. 30, 2025

(30) Foreign Application Priority Data
May 2, 2023 (NO) 20230504
Dec. 15, 2023 (NO) 20231360

(51) Int. Cl. H01M 10/54; C01B 32/20; H01M 4/02; H01M 4/583

(52) U.S. Cl. CPC H01M 10/54; C01B 32/20; H01M 4/583; C01P 2002/88; C01P 2006/11; C01P 2006/12; C01P 2006/40; C01P 2006/80; H01M 2004/021; H01M 2004/027

(57) ABSTRACT

A method for producing recycled graphite, a recycled graphite, and a battery, includes the steps of providing a reclaimed graphite concentrate including any one or more of carboxymethyl cellulose and styrene-butadiene rubber, pre-treating the reclaimed graphite concentrate by subjecting the reclaimed graphite concentrate to an oxidizing environment at a temperature in the range 250-380° C., thereby reducing the total concentration of carboxymethyl cellulose and styrene-butadiene rubber to less than 0.25%, and thermally treating the pre-treated reclaimed graphite concentrate by subjecting the pre-treated reclaimed graphite concentrate to a non-oxidizing environment at a temperature of at least 2300° C.

### FIELD OF INVENTION

The present invention relates to the field of graphite recycling.

### BACKGROUND

The demand for graphite has increased significantly in recent years, largely due to its use as anode material in lithium ion batteries, LIBs.

The limited lifetime of LIBs and the growing concerns about the environment have in later years attracted increased attention to recycling of end of life lithium ion batteries, EoL-LIBs. Recycling of EoL-LIBs has historically been focused on the extraction of metals such as cobalt, nickel and copper, but has increasingly also become focused on recycling of graphite. Graphite is not only recycled from EL-LIBs, but also from graphite residue left over from the production of battery anodes and cells. Recycling is today generally performed using any one or more of hydrometallurgical recycling, pyrometallurgical recycling, and direct recycling.

Pyrometallurgical processing is currently the most common method for recycling EoL-LIBs. The process generally relies on a combination of a chemical treatment and a high temperature treatment, but is often only used in order to recover metals, such as Ni and Co. Hydrometallurgical recycling and/or direct recycling is sometimes employed instead of or in addition to pyrometallurgical processing in order to recover other materials with overall higher recycling rates, such as graphite, from EoL-LIBs.

Hydrometallurgical recycling generally involves leaching of a black mass followed by a separation process. The separation may for example be performed using flotation methods, such as selective flotation or pyrolysis-ultrasonic-assisted flotation, whereas leaching may be performed using an acid or base. Flotation methods generally have the drawback of not achieving desirable purities, whereas the use of acids or bases for leaching have the drawback of creating unwanted environmental waste. Materials such as binders and heavy metals are further not properly removed through hydrometallurgical recycling, leading to a high density of these in the recycled graphite.

Direct recycling is as the name suggests, a relatively simple process where an anode material, e.g. graphite, is mechanically extracted. Direct recycling may for example involve a crushing step, followed by a sieving step in order to extract particles of a certain size. Direct recycling generally does not involve any refining of the recycled graphite, causing the recycled graphite to contain significant amounts of impurities such as metals, dust, residue binder, etc.

It is an aim of the present invention to provide a method for recycling graphite that addresses some of the issues with the prior art.

### SUMMARY OF THE INVENTION

A first aspect of the present invention provides a method for producing recycled graphite, the method comprising the steps of providing a reclaimed graphite concentrate comprising any one or more of carboxymethyl cellulose and styrene-butadiene rubber, pre-treating the reclaimed graphite concentrate by subjecting the reclaimed graphite concentrate to an oxidizing environment at a temperature in the range 250-380° C., thereby reducing the total concentration of carboxymethyl cellulose and styrene-butadiene rubber in the reclaimed graphite concentrate to less than 0.25 wt. %, and thermally treating the pre-treated reclaimed graphite concentrate by subjecting the pre-treated reclaimed graphite concentrate to a non-oxidizing environment at a temperature of at least 2300° C.

In an embodiment of the invention the method further comprises a step of mixing the pre-treated reclaimed graphite concentrate and a virgin binder into a blend prior to the step of thermally treating the pre-treated reclaimed graphite concentrate, wherein the step of thermally treating the pre-treated reclaimed graphite concentrate comprises subjecting the blend to a non-oxidizing environment at a temperature of at least 2300° C.

In another embodiment of the invention the ratio between the virgin binder and the pre-treated reclaimed graphite concentrate in the blend is in the range 3-12 wt. %, preferably in the range 6-8 wt. %.

In yet another embodiment of the invention the step of pre-treating the reclaimed graphite concentrate, the reclaimed graphite concentrate is subjected to an oxidizing environment at a temperature of at most 350° C.

In yet another embodiment of the invention the step of pre-treating the reclaimed graphite concentrate is performed such that the total concentration of carboxymethyl cellulose and styrene-butadiene rubber in the pre-treated reclaimed graphite concentrate is less than 0.2 wt. %.

In yet another embodiment of the invention the step of thermally treating the pre-treated reclaimed graphite concentrate is performed by subjecting the pre-treated reclaimed graphite concentrate to a non-oxidizing environment at a temperature in the range 2300° C.-2900° C.

In yet another embodiment of the invention the step of thermally treating the pre-treated reclaimed graphite concentrate is performed such that the concentration of any one or more of Copper, Nickel, Magnesium, Iron, Manganese, Aluminium, Lithium, Sulphur and Silicon in the thermally treated reclaimed graphite concentrate is less than 100 ppmw, preferably less than 20 ppmw.

In yet another embodiment of the invention the method further comprises a step of mixing the pre-treated reclaimed graphite concentrate with a virgin raw material prior to the step of thermally treating the pre-treated reclaimed graphite concentrate, wherein the virgin raw material is chosen from any one or more of petroleum coke, virgin synthetic graphite, and natural graphite, and wherein the step of thermally treating the pre-treated reclaimed graphite concentrate is performed by subjecting the pre-treated reclaimed graphite concentrate to a non-oxidizing environment at a temperature of at least 2300° C.

In yet another embodiment of the invention the reclaimed graphite concentrate comprises at least 90%, preferably at least 95%, and more preferably at least 99% carbon.

In yet another embodiment of the invention the reclaimed graphite concentrate comprises up to 1 wt. % of Copper, Nickel, Magnesium, Iron, Manganese, Aluminium, Lithium, Sulphur and Silicon.

In yet another embodiment of the invention the reclaimed graphite concentrate is anode scrap.

In yet another embodiment of the invention the step of pre-treating the reclaimed graphite concentrate comprises the sub steps of subjecting the reclaimed graphite concentrate to an oxidizing environment at a temperature in the range 250-380° C., thereby reducing the total concentration of carboxymethyl cellulose and styrene-butadiene rubber to less than 0.25% wt. %, and subsequently subjecting the reclaimed graphite concentrate from step i) to an oxidizing environment at a temperature in the range 500-600° C., preferably in the range 550-600° C.

A second aspect of the present invention provides recycled graphite comprising at most 0.25 wt. %, preferably at most 0.2 wt. %, of any one or more of carboxymethyl cellulose, styrene-butadiene rubber and residues thereof, and at most 0.01 wt. %, preferably at most 0.005%, of any one or more of Copper, Nickel, Magnesium, Iron, Manganese, Aluminium, Lithium, Sulphur and Silicon.

In an embodiment of the invention the recycled graphite has a tap density of at least 1 g/cc and/or an SSA BET of at most 2.0 m2/g.

A third aspect of the present invention provides use of the recycled graphite.

A third aspect of the present invention provides battery comprising the recycled graphite.

### BRIEF DESCRIPTION OF THE DRAWINGS

FIG. 1 is a schematic illustration of the method according to the present invention,

FIG. 2 is a schematic illustration of various embodiments of the method according to the present invention,

FIG. 3 is a schematic illustration of an example of a value chain for obtaining, and using recycled graphite according to the present invention,

FIG. 4 shows X-ray fluorescence analysis data showing the sublimation temperatures in Celsius for various metals in a reclaimed graphite concentrate,

FIG. 5 shows thermogravimetric analytic data for a sample of untreated reclaimed graphite concentrate, and for 6 different samples of reclaimed graphite concentrate that have been subjected to a pre-treatment in an oxidizing environment at various temperatures and times,

FIG. 6 is a table showing the pre-treatment conditions for the 6 different samples in FIG. 5 prior to thermogravimetric analysis, and the total amount of binder and binder residues in the 6 pre-treated samples and in the untreated reclaimed graphite concentrate,

FIG. 7 is a table containing qualitative data for a selection of samples of recycled graphite obtained via the method according to the present invention, samples of recycled graphite obtained through other methods, and a sample of virgin graphite,

FIG. 8 is a table containing qualitative data for an untreated graphite concentrate and a sample of recycled graphite obtained via the method according to the present invention from the same graphite concentrate, and

FIG. 9 includes an example of input parameters for a pre-treatment step according to the method of the present invention.

### DETAILED DESCRIPTION OF THE INVENTION

In the following, general embodiments as well as particular exemplary embodiments of the invention will be described. References will be made to the accompanying drawings. It shall be noted, however, that the drawings are exemplary embodiments only, and that other features and embodiments may well be within the scope of the invention as claimed. Further, the mentioning of references such as “a” or “an” etc. should not be construed as excluding a plurality. The term “invention” may herein be used interchangeably with the term “disclosure”. The term “producing” may herein be used interchangeably with the term “obtaining”.

Unless otherwise defined, all terms of art, notations and other scientific terms or terminology used herein are intended to have the meanings commonly understood by those of skill in the art to which this invention pertains. Certain terms of art, notations, and other scientific terms or terminology may, however, be defined specifically as indicated below.

The present invention provides a method for producing/obtaining recycled graphite from a reclaimed graphite concentrate. The present invention also provides a recycled graphite, use of a recycled graphite, and a battery comprising a recycled graphite. The method may be considered as a method for recycling graphite.

Reclaimed graphite concentrate may generally herein be defined as a reclaimed graphite-containing material. Reclaimed graphite concentrate may for example comprise graphite separated from one or more of EoL-LIBs and LIBs, and may additionally or optionally comprise graphite that is left over from manufacture of LIBs. Graphite that is left over from the manufacture of LIBs may generally be termed graphite scrap, and may be graphite reclaimed from any manufacturing step involved in the manufacture of LIBs, for example anode scrap. Certain examples of such manufacturing steps include but are not limited to slurry mixing, electrode casting and cell assembly. FIG. 3 schematically illustrates examples of sources for reclaimed graphite concentrate.

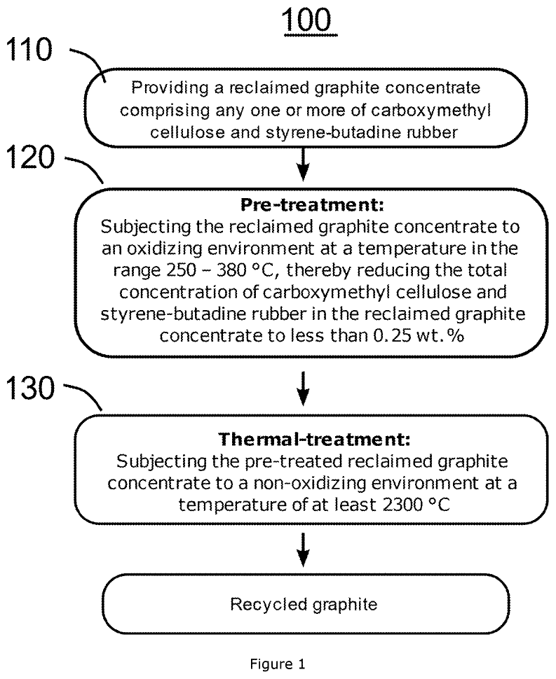

The method 100 according to the present invention comprises, as schematically illustrated in FIG. 1, a step of providing 110 a reclaimed graphite concentrate, followed by a step of pre-treating 120 a reclaimed graphite concentrate, and a step of thermally treating 130 the pre-treated reclaimed graphite concentrate. The step of pre-treating 120 the reclaimed graphite concentrate is generally configured to at least partly remove certain binders and/or binder residues from the reclaimed graphite concentrate. The step of thermally treating 130 the pre-treated reclaimed graphite concentrate may generally be configured to at least partly remove metallic impurities from the pre-treated reclaimed graphite concentrate. Thermally treated pre-treated reclaimed graphite concentrate may herein be termed recycled graphite.

The step of pre-treating 120 a reclaimed graphite concentrate may, as schematically illustrated in FIG. 1, be performed by subjecting the reclaimed graphite concentrate to an oxidizing environment at a temperature in the range 250-380° C. The step of pre-treating 120 is here performed in order to at least in part oxidize and remove any one or more of carboxymethyl cellulose (CMC) and styrene-butadiene rubber (SBR), and optionally any residues thereof from the reclaimed graphite concentrate. The reclaimed graphite concentrate may thus comprise any one or more of CMC, SBR, and any residues thereof. Residues may herein for example refer to molecules left over from thermal decomposition and/or chemical decomposition of CMC and/or SBR. The terms CMC and SBR may generally herein be interpreted as also including residues of CMC and SBR respectively.

CMC, SBR, and any residues thereof may be present in a reclaimed graphite concentrate due to the use of these binders during fabrication of anode and/or cathode electrodes for a LIB. More specifically, CMC, and/or SBR may for example be used in the coating process of an anode material on a copper foil as part of a cell manufacturing process for LIBs. Whether the reclaimed graphite concentrate comprises a binder, a binder residue or a combination of both will be appreciated by a person skilled in the art to be dependent on the exact origin of the reclaimed graphite concentrate.

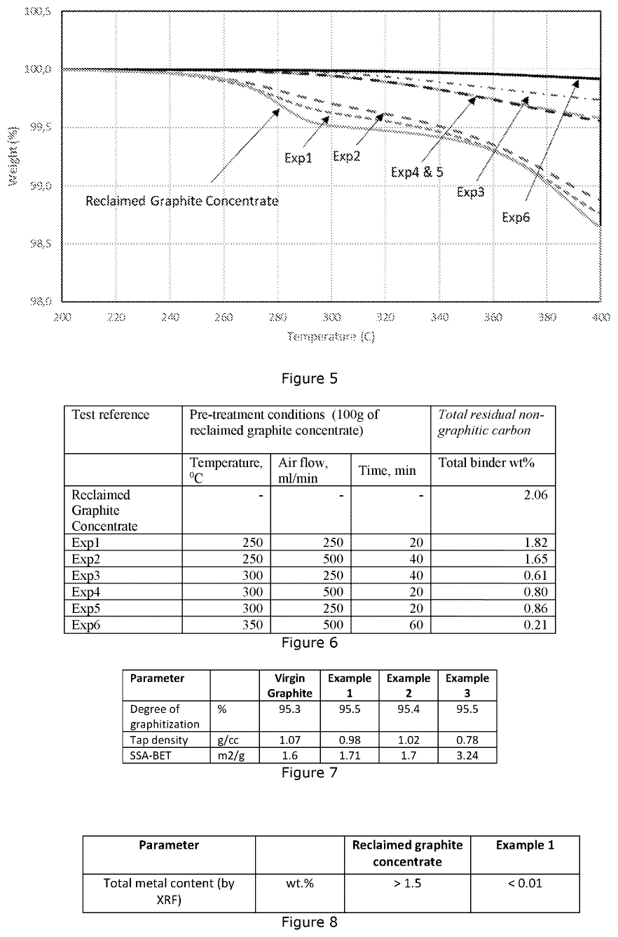

The use of a temperature in the range 250° C.-380° C. during the step of pre-treating the reclaimed graphite concentrate has been found to be suitable for removing any one or more of CMC, SBR, and any residues thereof. CMC and residues thereof have as indicated in FIG. 5 for example been found by the inventors to be possible to remove from a reclaimed graphite concentrate by subjecting the reclaimed graphite concentrate to an oxygen-containing environment at a temperature as low as 250° C. SBR and residues thereof have as indicated in FIG. 5 been found by the inventors to be possible to remove from a reclaimed graphite concentrate by subjecting the reclaimed graphite concentrate to an oxygen-containing environment at a temperature of as low as 300° C. The step of pre-treating the reclaimed graphite concentrate may thus according to an embodiment of the present invention be performed by subjecting the reclaimed graphite concentrate to an oxidizing environment a temperature of at least 250° C. or at least 300° C., where the exact temperature may be chosen depending on whether the reclaimed graphite concentrate comprises CMC, SBR or both CMC and SBR.

FIGS. 5 and 6 show thermogravimetric analytic data for a sample of reclaimed graphite concentrate that has not been subjected to any pre-treatment, and for 6 different samples of reclaimed graphite concentrate that have been subjected to a pre-treatment in an oxidizing environment at various temperatures, air-flow conditions and times. The former sample is labelled “reclaimed graphite concentrate”, whereas the latter 6 samples are labelled “Exp1-Exp6”. All the samples Exp1-Exp6 contained the same total amount of the binders CMC and SBR prior to the pre-treatment as the untreated reclaimed graphite concentrate. The thermogravimetric analytic data in FIG. 5 show for several of the samples a first shoulder at approximately 250° C.-300° C., and a second shoulder around 300° C.-380° C., more specifically around 300° C.-350° C. The first shoulder indicates that CMC may be removed at a temperatures as low as 250° C.-300° C., whereas the second shoulder indicates that SBR may be removed at temperatures as low as 300° C.-380° C., more specifically around 300° C.-350° C. As indicated in FIG. 6, the material Exp6 has undergone a pre-treatment of being subjected to an oxidizing an environment at 350° C. for 60 minutes prior to being measured using thermogravimetric analysis. The thermogravimetric data for Exp6 in FIG. 5 reveal no shoulders, nor any significant weight reduction, which means that Exp6 did not contain any substantial amount of CBC and SBR prior to the thermogravimetric analysis. The CMC and SBR that were present in Exp6 prior to subjecting Exp6 to the above-mentioned pre-treatment were thus largely removed during the pre-treatment.

The step of pre-treating the reclaimed graphite concentrate may for power-saving purposes preferably kept at an as low temperature as possible above the temperature required for removing any one or more of CMC, SBR, and any residues thereof present in reclaimed graphite concentrate. If the reclaimed graphite concentrate does not contain SBR, the step of pre-treating the reclaimed graphite concentrate may for example be performed at a temperature in the range 250° C.-300° C. If the reclaimed graphite concentrate does contain SBR, the step of pre-treating the reclaimed graphite concentrate may be performed at a temperature as low as 300° C.-380° C., preferable as low as 300° C.-350° C.

The step of pre-treating the reclaimed graphite concentrate may thus generally be performed by subjecting the reclaimed graphite concentrate to an oxidizing environment a temperature of at least 250° C., or at least 300° C., where the exact temperature may be chosen depending on whether the reclaimed graphite concentrate comprises CMC, SBR or both CMC and SBR. The step of pre-treating the reclaimed graphite concentrate may further be performed by subjecting the reclaimed graphite concentrate to an oxidizing environment a temperature of at most 300° C., 350° C. or 380° C., where the exact temperature may be chosen depending on whether the reclaimed graphite concentrate comprises CMC, SBR or both CMC and SBR. An upper limit of 380° C., preferably 350° C. is preferable in order to avoid unwanted oxidation of the graphite in the reclaimed graphite concentrate, while at the same time obtain removal of CMC, SBR or both CMC and SBR. The conditions during the step of pre-treating the reclaimed graphite concentrate may generally be chosen such that a desired portion of any one or more of CMC, SBR, and any residues thereof in the reclaimed graphite concentrate is removed. The step of pre-treating the reclaimed graphite concentrate may more specifically be performed such that the concentration of CMC, SBR, and optionally any residues thereof in the pre-treated reclaimed graphite concentrate is less than 0.25 wt. %, preferably less than 0.2 wt. % Removal of CBC and/or SBR prior to a step of thermal treatment at elevated temperatures has been found to be preferable in order to obtain a high tap density and a low Brunauer, Emmett, and Teller (BET) surface area after a subsequent step of thermally treating the pre-treated reclaimed graphite concentrate. The latter may be seen in FIG. 7, where the sample in example 1 has been subjected to a pre-treatment according to the present invention prior to a thermal treatment at elevated temperatures, whereas the sample in example 3 has been subjected only to thermal treatment at elevated temperatures. It has generally been found that a recycled graphite material with a tap density of at least 1 g/cc and/or an SSA BET of at most 2 m²/g, e.g. 2.0 m²/g, may be obtained.

As will be appreciated by a person skilled in the art with knowledge of the present invention, the exact amount of the CMC, SBR, and any residues thereof removed from the reclaimed graphite concentrate during of the step of pre-treating the reclaimed graphite concentrate may vary based on the combination of several process parameters. Such parameters may comprise any one or more of the duration of the pre-treatment, the temperature during the pre-treatment, the degree of stirring during, the particle size of the reclaimed graphite concentrate, the amount of reclaimed graphite concentrate undergoing the pre-treatment, and the concentration of oxygen in the oxidizing environment. The step of pre-treating the reclaimed graphite concentrate may for example generally proceed for a time in the range 0.5-5 hours, preferably for a time in the range 0.5-2 hours, even more preferably in the range 0.5-1 hour. FIG. 6 shows several examples of conditions during a step of pre-treating a reclaimed graphite concentrate.

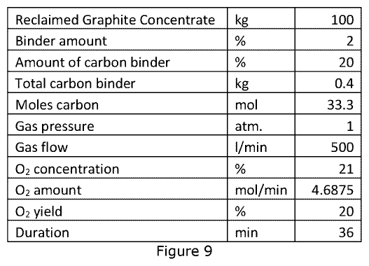

The step of pre-treating the reclaimed graphite concentrate generally involves subjecting the reclaimed graphite concentrate to an oxidizing environment. As will be appreciated by a person skilled in the art with knowledge of the present invention, the concentration of oxygen in the oxidizing environment may vary. The concentration of oxygen in the oxidizing environment may for example be that of air. In a more general example, the concentration of oxygen in the oxidizing environment may be in the range 10%-20%. It will be appreciated by a person skilled in the art, however, that the exact concentration of oxygen in the oxidizing environment may be chosen based on a balance estimate, i.e. where the concentration of oxygen in the oxidizing environment is chosen according to the duration and temperature of the pre-treatment step and the amount of non-graphitic carbon in the reclaimed graphite concentrate that is sought to be removed. A rough approximation that may be used for estimating the time required to remove a certain amount of non-graphitic carbon from reclaimed graphite concentrate during the pre-treatment may be made by solving the following equation for time: Time [min]*Gas flow [l/min]*Gas pressure [atm]/22.4 l/mol*O₂ concentration gas [%]*O₂ yield [%]=RGC [kg]*Binder/carbon amount [%]*Carbon share/Fixed Carbon [%]*12 g/mol. The table in FIG. 9 includes an example of input parameters for a pre-treatment step.

The step of pre-treating the reclaimed graphite concentrate may generally be conducted in any suitable pre-treatment equipment, such as for example a rotary kiln, a heat mixer, tube furnace, fluidized bed reactor, or similar. As will be appreciated by a person skilled in the art with knowledge of the present invention, the step of pre-treating the reclaimed graphite concentrate may be performed in a pre-treatment equipment configured to subject the reclaimed graphite concentrate to an oxidizing environment at a temperature in the range 250° C.-380° C., or optionally 250° C.-350° C. Said pre-treatment equipment may more specifically be configured to subject the pre-treated reclaimed graphite concentrate an oxygen-containing purging gas. The pre-treatment equipment may for example comprise a reaction chamber, a heat source, a thermostat, a gas inlet and a gas outlet.

The step of pre-treating the reclaimed graphite concentrate may according to an embodiment of the invention comprise two sub-steps, i.e., sub-step i) and sub-step ii). In sub-step i), the reclaimed graphite concentrate is subjected to an oxidizing environment at a temperature in the range 250-380° C. The step of pre-treating the reclaimed graphite concentrate may thus reduce the total concentration of CBC and SBR, and optionally residues thereof, to less than 0.25% wt. % In sub-step ii), the reclaimed graphite concentrate from sub-step i) is subjected to an oxidizing environment at a temperature in the range 500-600° C., preferably in the range 550-600° C. Sub-step ii) may here be conducted in order to remove conductive additives, such as carbon black, from the reclaimed graphite concentrate, while at the same time limit oxidation of the graphite in the reclaimed graphite concentrate as compared to performing the whole step of pre-treating the reclaimed graphite concentrate at a temperature in the range 500-600° C. The employment of separate sub-steps i) and ii) allows the execution of prolonged heat treatment at low temperature, i.e., in the range 250-380° C. followed by a shorter heat treatment at a higher temperature, i.e., in the range 500-600° C. The employment of such sub-steps i) and ii) thus enables the removal of CBC and SBR and other conductive additives, such as carbon black, from the reclaimed graphite concentrate with limited oxidation to the graphite in the reclaimed graphite concentrate. Sub-step i) may here for example last for a time X, whereas the sub-step ii) may last for a time Y, where X>Y. It will be appreciated by a person skilled in the art with knowledge of the present invention that X and Y may vary based on the exact properties of the reclaimed graphite concentrate. As a way of example, X may be 1 hour and Y may be 10 minutes.

The reclaimed graphite concentrate may according to a particular embodiment of the present invention be electrode scrap, e.g., anode scrap. Electrode scrap may here be graphite electrode scrap, e.g., reject, from electrode manufacturing, or more specifically anode manufacturing. Anode scrap may typically comprise graphite, and SBR and CMC, for example with 95-97 wt. % graphite and optionally a combined amount of SBR and CMC of 3-5 wt. %. The anode scrap may for example be obtained by separation from a copper foil, and the anode scrap may thus comprise copper impurities. As a way of example, the anode scrap may comprise 0.1-2 wt. % copper. Anode scrap may for example not comprise any other binders than SBR and CMC. Anode scrap may in other words be graphite anode scrap, i.e., spent graphite anode material.

The method 100 according to the present invention comprises, as schematically illustrated in FIG. 1, a step of thermally treating 130 the pre-treated reclaimed graphite concentrate. The step of thermally treating 130 the pre-treated reclaimed graphite concentrate is performed after the pre-treatment step, and involves subjecting the pre-treated reclaimed graphite concentrate to a non-oxidizing environment at a temperature of at least 2300° C. The duration of the step of thermally treating 130 the pre-treated reclaimed graphite concentrate may for example be in the range 0.5-5 hours, more preferably in the range 1-3 hours. Pre-treated reclaimed graphite concentrate may herein be understood as a material comprising reclaimed graphite concentrate that has undergone the pre-treatment 120 step described above.

The non-oxidising environment in the step of thermally treating the pre-treated reclaimed graphite concentrate may generally be an environment where no oxygen is intentionally added. An example of a non-oxidising environment is an environment constantly purged with an inert gas, such as argon or nitrogen. The total oxygen concentration in said non-oxidising environment may generally be at most 0.1%, preferably at most 0.05%, and even more preferably at most 0.01%. A non-oxidizing environment is herein chosen in order to limit oxidation of any graphite component of pre-treated reclaimed graphite concentrate. It will be appreciated by a person skilled in the art, however, that some unwanted oxidation during the thermal treatment of the graphite component of pre-treated reclaimed graphite concentrate may be inevitable. Unwanted oxidation may for example occur due to the presence of oxygen impurities in any purge gas used, residue of moisture or air inside the equipment used to perform the thermal treatment, or leakage of air inside the equipment used to perform the thermal treatment.

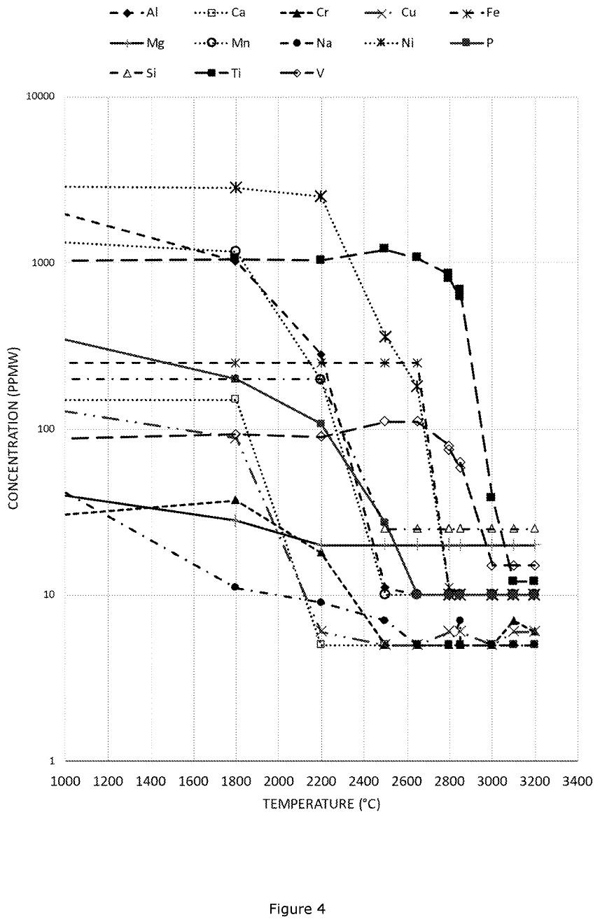

The step of thermally treating the pre-treated reclaimed graphite concentrate may be performed in order to reduce the amount of metallic impurities present in the pre-treated reclaimed graphite concentrate. The temperature during the step of thermally treating the pre-treated reclaimed graphite concentrate is according to the present invention at least 2300° C. A temperature of 2300° C. has been found by the inventors to be a threshold for sublimation of most metal impurities typically found in reclaimed graphite concentrate, with the exception of for example iron, nickel, titanium, and vanadium. FIG. 4 shows sublimation temperatures for various metallic impurities in pre-treated graphite concentrate as measured with X-ray fluorescence analysis (XRF). A thermal treatment in a non-oxidizing environment at a temperature of at least 2300° C., preferably at least 2400° C., has been found to remove copper, silicon, manganese, magnesium, sodium, chromium, calcium, phosphorus and aluminium from reclaimed graphite concentrate. A thermal treatment in a non-oxidizing environment at a temperature of at least 2800° C. has additionally been found to cause the sublimation and thus removal of iron, and nickel. Iron may be particularly unwanted in recycled graphite due to its role in causing unwanted electrochemical side reactions reducing the lifetime of the LIB when the recycled graphite is used as an anode material. At a temperature of at least 2900° C., it can be seen from FIG. 4 that sublimation of vanadium and titanium occurs. As vanadium and titanium rarely are found in significant concentrations in LIBs, it may not be required to perform the step of thermally treating the pre-treated reclaimed graphite concentrate at a temperature above 2900° C. According to a particular embodiment of the present invention the step of thermally treating the pre-treated reclaimed graphite concentrate is performed by subjecting the pre-treated reclaimed graphite concentrate to a non-oxidizing environment at a temperature in the range 2300° C.-2900° C., preferably in the range 2400° C.-2900° C., and more preferably in the range 2800° C.-2900° C. Keeping the temperature during the thermal treatment as low as possible, more specifically at 2900° C. or below is considered preferable in order to obtain the above-mentioned sublimation while at the same time reducing equipment wear and limiting power consumption as compared to use of higher temperatures. Optionally, the thermal treatment may be performed at up to 3200° C., as this temperature has been found to be the lowest threshold that may enable removal of many higher sublimation point elements such as titanium and vanadium to below 20 ppmw. In a particular embodiment of the invention the step of thermally treating the pre-treated reclaimed graphite concentrate is performed such that the concentration of any one or more of, i.e. the sum of the concentration of, Copper, Nickel, Magnesium, Iron, Manganese, Aluminium, Lithium, Sulphur and Silicon in the thermally treated reclaimed graphite, concentrate is less than 100 ppmw, preferably less than 20 ppmw. High purity in the recycled graphite may, when used as anode material in new LIBs, generally be linked with longer lifetimes of the LIB as some metals will be electrochemically active and cause unwanted side-reaction during repeated cycling.

FIG. 8 shows the total amount of metallic impurities for a sample of untreated reclaimed graphite concentrate and a sample of the same reclaimed graphite concentrate having been pre-treated at 350° C. in air atmosphere for 60 min in a heated mixer and then thermally treated at 3000° C. for 2 hours. The total amount of metallic impurities can here be seen to be above 1.5 wt. % untreated reclaimed graphite concentrate and to be below 0.01 wt. % for the reclaimed graphite concentrate having been subjected to a thermal treatment.

In the embodiment where the reclaimed graphite concentrate is anode scrap, the step of thermally treating the pre-treated reclaimed graphite concentrate may be performed by subjecting the pre-treated reclaimed graphite concentrate to a non-oxidizing environment at a temperature in the range 2300° C.-2500° C., preferably in the range 2300° C.-2400° C. Said temperature range may be chosen to remove any one or more of copper and silicon from the anode scrap, as silicon may be present in the anode scrap in a concentration above 1 wt. %. The upper temperature limit may here be chosen in order limit equipment wear, and power consumption, and/or allow for a limited off-gas/emission production. At least part of any iron present in the anode scrap may optionally be removed by magnetic separation.

The step of thermally treating the pre-treated reclaimed graphite concentrate may as a way of example be conducted in an induction furnace. As will be appreciated by a person skilled in the art with knowledge of the present invention, the step of thermally treating the pre-treated reclaimed graphite concentrate may be performed in a thermal treatment equipment configured to subject the pre-treated reclaimed graphite concentrate to a non-oxidizing environment at a temperature of at least 2300° C. Said thermal treatment equipment may more specifically be configured to subject the pre-treated reclaimed graphite concentrate to a temperature of at least 2300° C. while constantly subjecting the pre-treated reclaimed graphite concentrate to an inert purging gas. The step of thermally treating the pre-treated reclaimed graphite concentrate may thus further involve condensing metallic impurities from the purge gas in a condenser unit, where the condenser unit optionally is separate from an induction furnace employed to carry out the step of thermally treating the pre-treated reclaimed graphite concentrate. The latter is preferable to using a conventional Acheson furnace where metallic impurities will accumulate inside the furnace.

The method according to the present invention may generally be employed using wide range of reclaimed graphite concentrates. However, it is preferable that the reclaimed graphite concentrate comprises at least 90%, preferably at least 95%, and more preferably at least 99% carbon. Said levels of carbon may allow for a limited duration for the pre-treatment and thermal treatment steps, and may also allow for a higher portion of graphite in the recycled graphite obtained by the method. At least 90% of carbon in the reclaimed graphite concentrate may be considered as a lower limit in order to practically allowing the method according to the invention to be performed, i.e. without having to run the various steps for a duration that would make the method uneconomical, cause unwanted wear on equipment, and/or cause a too high requirement for off-gas/emission handling. The reclaimed graphite concentrate may additionally, or optionally comprise a limited amount of metallic impurities prior to being treated using the method according to the present invention. The reclaimed graphite concentrate may in a particular embodiment of the present invention comprise up to 1 wt. % of Copper, Nickel, Magnesium, Iron, Manganese, Aluminium, Lithium, Sulphur and Silicon, i.e. as an accumulated amount. Said amount of metallic impurities may allow for a limited required duration of the thermal treatment step, allow for an acceptable equipment wear and/or allow for a limited off-gas/emission production.

The reclaimed graphite concentrate may generally undergo the step of pre-treatment without first having been subjected to any acid leaching. The method for producing recycled graphite may additionally not comprise any step of acid leaching.

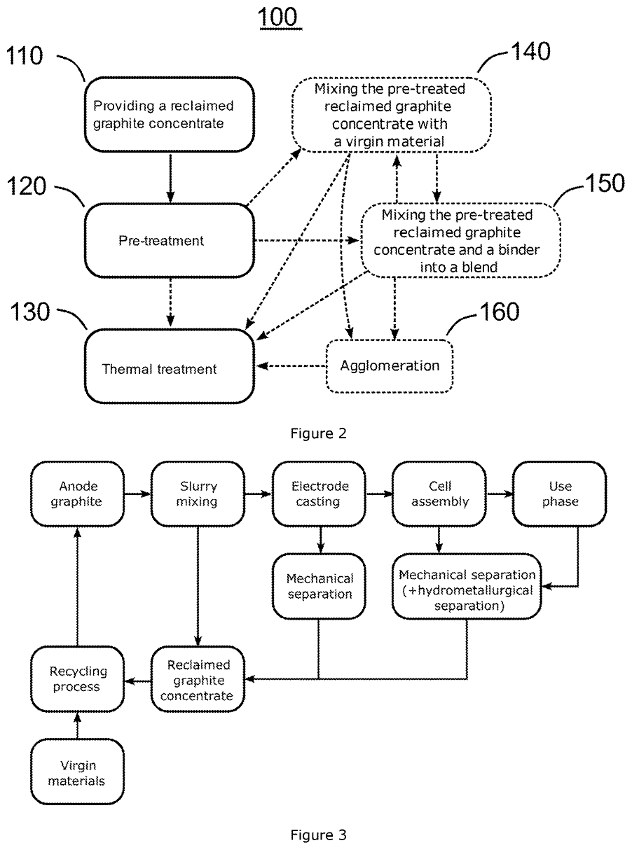

In certain recycling processes it may be preferable to treat reclaimed graphite concentrate with a carbon content below 90% and with a metallic impurity concentration above 1%. For such qualities of the reclaimed graphite concentrate it may be possible to improve the overall quality of the reclaimed graphite concentrate or the pre-treated reclaimed graphite concentrate by mixing reclaimed graphite concentrate or pre-treated reclaimed graphite concentrate with a virgin raw material, e.g. comprising above 90% carbon and/or comprising a metallic impurity concentration that is lower than 1%. FIG. 2 schematically illustrates a particular embodiment of the invention where the method 100 further comprises a step of mixing 140 the pre-treated reclaimed graphite concentrate with a virgin raw material prior to the step of thermally treating 130 the pre-treated reclaimed graphite concentrate. The virgin raw material may for example be chosen from one or more of petroleum coke, virgin synthetic graphite, and natural graphite. The virgin raw material may for example comprise least 90% of carbon and comprise at most 1 wt. % of Copper, Nickel, Magnesium, Iron, Manganese, Aluminium, Lithium, Sulphur and Silicon, i.e. as an accumulated amount.

Pre-treated reclaimed graphite concentrate may as schematically illustrated in FIG. 2 be mixed with other additives prior to the step of thermally treating 130 the pre-treated reclaimed graphite concentrate. Such additives may for example comprise a virgin binder. A virgin binder may herein be defined as one or more of coal tar pitch, petroleum pitch and asphalt/bitumen. In a particular embodiment of the present invention the method for producing recycled graphite from a graphite concentrate may further comprise a step of mixing 150 the pre-treated reclaimed graphite concentrate and a virgin binder into a blend prior to the step of thermally treating 130 the pre-treated reclaimed graphite concentrate. Adding a virgin binder to the pre-treated reclaimed graphite concentrate prior to the thermal treatment 130 may be performed in order to agglomerate and coat graphite particles prior to the thermal treatment 130. The ratio between the binder and the pre-treated reclaimed graphite concentrate in the blend may preferably in the range 3-12 wt. %, more preferably in the range 6-8 wt. %. The latter ranges has empirically been shown to result in improved agglomeration after the subsequent thermal treatment 130. The method 100 for producing recycled graphite from a graphite concentrate may further comprises a step of agglomerating 160 the blend at a temperature in the range 800-1100° C. prior to the step of thermally treating 130 the pre-treated reclaimed graphite. Such an agglomeration 160 has been shown to cause a lower degree of orientation in the recycled graphite resulting from the method 100 as compared to if the agglomeration was not employed. The step of mixing 140 the pre-treated reclaimed graphite concentrate with a virgin raw material may generally be performed before or after the optional step of mixing 150 the pre-treated reclaimed graphite concentrate and a virgin binder into a blend. The step of thermally treating the pre-treated reclaimed graphite concentrate may cause graphitization, in part or complete, of the virgin binder.

The present invention also provides a recycled graphite comprising at most 0.25 wt. %, preferably at most 0.2 wt. % of CBC and SBR and optionally residues thereof, and at most 0.01 wt. %, preferably at most 0.005%, of any one or more of Copper, Nickel, Magnesium, Iron, Manganese, Aluminium, Lithium, Sulphur and Silicon. The total combined amount of CBC, SBR and residues thereof may thus be at most 0.25 wt. %, preferably at most 0.2 wt. %. The total combined amount of Copper, Nickel, Magnesium, Iron, Manganese, Aluminium, Lithium, Sulphur and Silicon may thus be at most 0.01 wt. %, preferably at most 0.005%. The recycled graphite may additionally have any one or more of a tap density of at least 1 g/cc and an SSA BET of at most 2 m²/g, e.g. 2.0 m²/g. The recycled graphite may generally be obtained via any embodiment of the method according to the present invention. Binder residues may thus refer generally to residues of any one or more of CBC and SBR, e.g. molecules left over from thermal decomposition and/or chemical decomposition of said binders.

The recycled graphite may generally be employed for producing an anode for a LIB. The exact method for producing said anode may vary, as will be appreciated by a person skilled in the art. An aspect of the present invention thus provides a battery comprising the recycled graphite according to the second aspect of the invention. Another aspect of the present invention comprises using the recycled graphite described here in an anode of a battery.

### EXAMPLES

FIG. 7 shows an overview of various materials that have been obtained using different exemplary methods labelled example 1-3:

Example 1: A reclaimed graphite concentrate was pre-treated at 350° C. in air atmosphere for 60 min in a heated mixer. The pre-treated material was then thermally treated at 3000° C. for 2 hours.

Example 2: A reclaimed graphite concentrate was subjected to a pre-treatment in a heated mixer at 350° C. in air atmosphere for 60 min. The pre-treated reclaimed graphite concentrate was then mixed with a pitch binder into a blend, such that the blend comprised 8% pitch, and subsequently agglomerated and heat treated at 1000° C. The agglomerated blend was then thermally treated at 3000° C. for 2 hours to make a recycled graphite.

Example 3: A reclaimed graphite concentrate was directly thermally treated at 3000° C. for 2 hours.

1. A method for producing recycled graphite, the method comprising:
providing a reclaimed graphite concentrate comprising one or more of carboxymethyl cellulose and styrene-butadiene rubber;
pre-treating the reclaimed graphite concentrate by subjecting the reclaimed graphite concentrate to an oxidizing environment at a temperature in a range 250-380° C., thereby reducing a total concentration of carboxymethyl cellulose and styrene-butadiene rubber in the reclaimed graphite concentrate to less than 0.25 wt. %; and
thermally treating the pre-treated reclaimed graphite concentrate by subjecting the pre-treated reclaimed graphite concentrate to a non-oxidizing environment at a temperature of at least 2300° C.

2. The method according to claim 1, further comprising mixing the pre-treated reclaimed graphite concentrate and a virgin binder into a blend prior to the thermally treating the pretreated reclaimed graphite concentrate, the thermally treating the pre-treated reclaimed graphite concentrate comprising subjecting the blend to a non-oxidizing environment at a temperature of at least 2300° C.

3. The method according to claim 2, wherein a ratio between the virgin binder and the pre-treated reclaimed graphite concentrate in the blend is in the range 3-12 wt. %.

4. The method according to claim 1, wherein the pre-treating the reclaimed graphite concentrate comprises subjecting the reclaimed graphite concentrate to an oxidizing environment at a temperature of at most 350° C.

5. The method according to claim 1, wherein the pre-treating the reclaimed graphite concentrate is performed such that the total concentration of carboxymethyl cellulose and styrene-butadiene rubber in the pre-treated reclaimed graphite concentrate is less than 0.2 wt. %.

6. The method according to claim 1, wherein the thermally treating the pre-treated reclaimed graphite concentrate comprises subjecting the pre-treated reclaimed graphite concentrate is subjected to a nonoxidizing environment at a temperature in a range 2300° C.-2900° C.

7. The method according to claim 1, wherein the thermally treating the pre-treated reclaimed graphite concentrate is performed such that a concentration of one or more of copper, nickel, magnesium, iron, manganese, aluminum, lithium, sulphur, and silicon in the thermally treated reclaimed graphite concentrate is less than 100 ppmw.

8. The method according to claim 1, further comprising mixing the pre-treated reclaimed graphite concentrate with a virgin raw material prior to the thermally treating the pre-treated reclaimed graphite concentrate,
wherein the virgin raw material is chosen from one or more of petroleum coke, virgin synthetic graphite, and natural graphite, and
wherein the thermally treating the pre-treated reclaimed graphite concentrate comprises subjecting the pre-treated reclaimed graphite concentrate to a non-oxidizing environment at a temperature of at least 2300° C.

9. The method according to claim 1, wherein the reclaimed graphite concentrate comprises at least 90% carbon.

10. The method according to claim 1, wherein the reclaimed graphite concentrate comprises up to 1 wt. % of copper, nickel, magnesium, iron, manganese, aluminum, lithium, sulphur, and silicon.

11. The method according to claim 1, wherein the reclaimed graphite concentrate is anode scrap.

12. The method according to claim 1, wherein the pre-treating the reclaimed graphite concentrate comprises
subjecting the reclaimed graphite concentrate to an oxidizing environment at a temperature in a range 250-380° C., thereby reducing the total concentration of carboxymethyl cellulose and styrene-butadiene rubber to less than 0.25% wt. %, and subsequently
subjecting the reclaimed graphite concentrate from to an oxidizing environment at a temperature in a range 500-600° C.

13. A recycled graphite comprising:
at most 0.25 wt. % of one or more of carboxymethyl cellulose, styrene-butadiene rubber, and residues thereof; and
at most 0.01 wt. % of one or more of copper, nickel, magnesium, iron, manganese, aluminum, lithium, sulphur, and silicon.

14. The recycled graphite according to claim 13, wherein the recycled graphite has one or more of: (i) a tap density of at least 1 g/cc and (ii) an SSA BET of at most 2.0 m2/g.

15. A method comprising:
providing the recycled graphite according to claim 13 in an anode of a battery.

16. A battery comprising:
the recycled graphite according to claim 13.

17. The method according to claim 1, wherein the reclaimed graphite concentrate comprises at least 95% carbon.

18. The method according to claim 1, wherein the reclaimed graphite concentrate comprises at least 99% carbon.

19. The method according to claim 12, wherein the reclaimed graphite concentrate is subjected to the oxidizing environment at the temperature in a range 550-600° C.

20. The recycled graphite according to claim 12, further comprising at most 0.20 wt. % of one more of carboxymethyl cellulose, styrene-butadiene rubber, and residues thereof.
